(19) United States
(12) Patent Application Publication
(10) Pub. No.: US 2024/0125467 A1
(43) Pub. Date: Apr. 18, 2024

(54) WELLNESS SYSTEM AND DEVICE

(71) Applicant: Kohler Co., Kohler, WI (US)

(72) Inventors: Huston Adam Sprang, Sheboygan, WI (US); Peter Kajuch, Brookfield, WI (US); Robert Quasius, Kohler, WI (US); Aaron Mitchell, Grafton, WI (US); James Scott Giefer, Sheboygan, WI (US); Gary Clarke, Kohler, WI (US); Jessica Schroeder, Sheboygan, WI (US); Maria Evraets, Sheboygan Falls, WI (US); Amber LaVerne Hall Nelson, Grand Rapids, MI (US); Yutong Wu, Sheboygan, WI (US); Evan See-Leet Lee, Port Washington, WI (US); Thomas Brian Sindelar, Menomonee Falls, WI (US); Crystal Marie Riste, Port Washington, WI (US); Ryan Leichty, Kohler, WI (US); Zachary Paul Hillesland, Evanston, IL (US)

(21) Appl. No.: 18/371,841

(22) Filed: Sep. 22, 2023

Related U.S. Application Data
(60) Provisional application No. 63/415,433, filed on Oct. 12, 2022.

(51) Int. Cl. F22B 1/28; A61H 33/00; A61H 33/06; A61H 33/10

(52) U.S. Cl. CPC F22B 1/284; A61H 33/065; A61H 33/10; A61H 33/6005; A61H 2033/068; A61H 2201/0107; A61H 2201/0157; A61H 2201/0188; A61H 2201/102; A61H 2201/5035

(57) ABSTRACT

A portable steam generator includes a power source in a housing, a water tank in the housing, a heating element in the housing and configured to heat water in the water tank to produce steam using power from the power source, and a track on the housing configured to support the portable steam generator in an installation position and allow manual removal from the installation position. A pre-plumbed integrated bathroom panel includes a plumbing inlet configured to provide water to the panel, a water outlet connected to the plumbing inlet, a steam outlet connected to the plumbing inlet and a heating element, a sanitizing outlet connected to the plumbing inlet and an additive generator, valves for directing water from the plumbing inlet to the at least one water outlet, the at least one steam outlet, and the at least one sanitizing outlet, and a controller configured to operate at least the plurality of valves.

### CROSS REFERENCE TO RELATED APPLICATIONS

This application claims priority benefit of Provisional Application No. 63/415,433 (Docket No. 10222-22046A) filed Oct. 12, 2022, which is hereby incorporated by reference in its entirety.

### FIELD

The present application relates to wellness systems and devices.

### BACKGROUND

The bathroom may serve as a portal into the life and habits of users. It is one of the few places where people reliably visit and can be monitored at nearly the same location almost every day. Further, the bathroom is an ideal site for the administration of treatment for the users. The health and wellbeing of users may be monitored and/or supplemented according to the following devices and systems.

### BRIEF DESCRIPTION OF THE DRAWINGS

Exemplary embodiments are described herein with reference to the following drawings, according to an exemplary embodiment.

FIG. 1 illustrates a portable steam generator.

FIG. 2 illustrates a block diagram for the portable steam generator.

FIG. 3 illustrates a user interface for the portable steam generator.

FIG. 4 illustrates example mounting locations for the portable steam generator.

FIG. 5 illustrates an example flow chart for the portable steam generator.

FIG. 6 illustrates an example integrated shower panel.

FIG. 7 illustrates an example recirculation system for the integrated shower panel.

FIG. 8 illustrates another example recirculation system for the integrated shower panel.

FIG. 9 illustrates an example integrated lavatory panel.

FIG. 10 illustrates an example dispensing system for a lavatory.

FIG. 11 illustrates a flow chart for the integrated lavatory panel.

FIG. 12 illustrates an example recommendation system.

FIG. 13 illustrates an example light guide for the recommendation system.

FIG. 14 illustrates a flow chart for the recommendation system.

FIG. 15 illustrates an example shower exercise system.

FIG. 16 illustrates an example installation sequence for the shower exercise system.

FIG. 17 illustrates an example a bubble generation system.

FIG. 18 illustrates an example flow chart for the bubble generation system.

FIG. 19 illustrates an example controller for any of the disclosed embodiments.

### DETAILED DESCRIPTION

The following embodiments includes methods, apparatus, and system to track, monitor, and improve the wellbeing of people through bathroom devices or other interactions of the user in the bathroom. Some devices interact with consumers to tailor experiences and product recommendations. These devices may investigate customer schedules to understand wellness such as (a state of being stressed, sick, or anxious) and recommend shower, faucet, scent, or bath routines. Through mirrors or other surfaces, the bathroom may include augmented reality with projectors and/or mesh light emitting diode (LED) glass technology. Bathroom sequences or exercise routines that are interactive may be provided.

The following embodiments include plumbing devices such as faucets, bathtubs, and showers. The term “plumbing fixture” refers to an apparatus that is connected to a plumbing system of a house, building or another structure. The term “bathroom fixture” may more specifically refer to individual types of plumbing fixtures found in the bathroom.

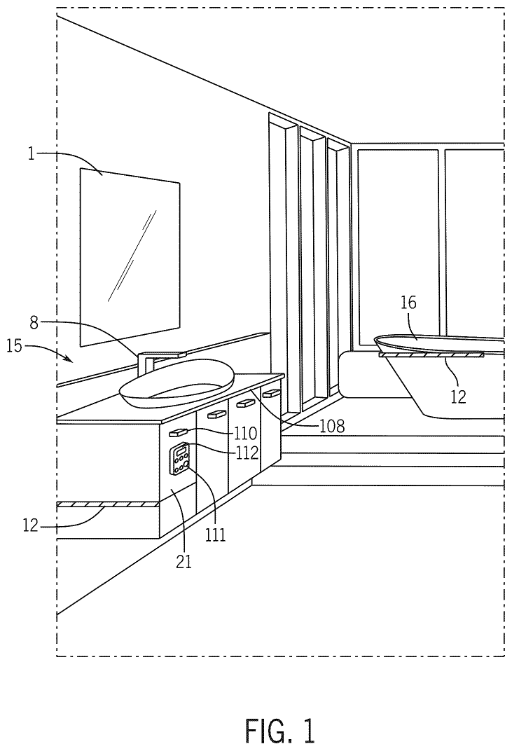

FIG. 1 illustrates a portable steam generator 21. The portable steam generator 21 may be removably connected to one or more bathroom devices or plumbing fixtures. The portable steam generator 21 generates steam in a variety of locations. For example, the portable steam generator 21 may mounted on a sink or lavatory 15 or on a bathtub 16, as shown by the tracks 12 in FIG. 1. Additional examples are described below.

The portable steam generator 21 may be installed and removed along a track 12. The track 12 may support the weight of the portable steam generator 21 or the track 12 may align the portable steam generator 21 onto another support structure. The track 12 may align the portable steam generator 21 with a plumbing fixture and/or an electrical fixture. The plumbing fixture may provide water to the portable steam generator 21 or dispense the steam from the portable steam generator 21. The electrical fixture may provide electrical current to a heating element or battery of the portable steam generator 21. The portable steam generator 21 may include a track (e.g., rail) on the housing configured to support the portable steam generator in an installation position and allow manual removal from the installation position. Additional, different, or fewer components may be included.

In one example, the portable steam generator 21 is installed in a lavatory 15 including a faucet 8 and a counter top 108. The portable steam generator 21 may share and be coupled to the plumbing fixture of the faucet 8. The lavatory may also include an electrical outlet or other power connection for the portable steam generator 21. The portable steam generator 21 may include a handle 110. The user may grip the handle 110 on the front face to slide and then lift the portable steam generator 21 along the track 12 in order to remove the portable steam generator 21 from the lavatory 15. The portable steam generator 21 with the handle 110 may visually appear similar to a drawer in the lavatory 15. The face of the drawer may also include a display 111 and/or a user input 112, which are discussed in more detail below.

Another mounting location in FIG. 1 is in or adjacent to a bathtub 16 where the track 12 allows the portable steam generator 21 to be installed and supported by the bathtub 16. In some examples, the portable steam generator 21 may be submerged in the bathtub 16, and in other examples, the portable steam generator 21 may mounted on the outside of the bathtub 16 or above the water level of the bathtub 16.

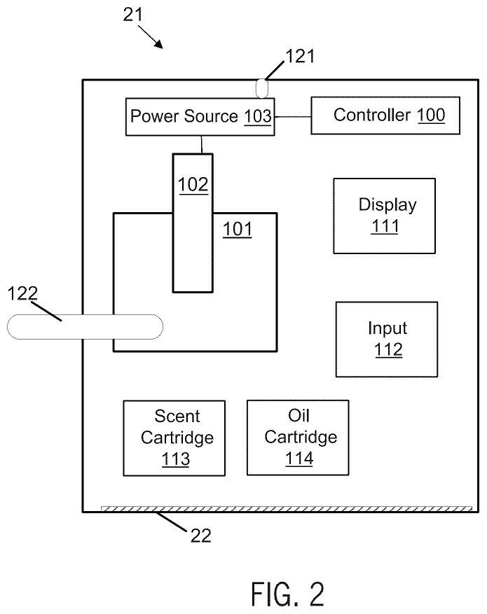

FIG. 2 illustrates a block diagram for the portable steam generator 21. The portable steam generator 21 may include a controller 100, a tank 101, a heating element 102, a power source 103, a display 111, an input 112, scent cartridge 113, oil cartridge 114, an electrical connector 121, and a water connector 122. In some examples, the portable steam generator 21 may include a rail 11 that mates with or otherwise corresponds to the track 12. Additional, different, or fewer components may be included.

For the general operation of the portable steam generator 21, the power source 103 supplies energy to the heating element 102 to heat the water in the tank 101 and produce steam. The heating element 102 may include a resistive heater that heats the water to the boiling point of water. The housing of the portable steam generator 21 may include one or more vents to allow the steam to escape. In some examples, the steam exhaust includes a hose that the user can manipulate to provide the steam in a wide range of positions.

The power source 103 may include one or more batteries configured to store electrical energy for operation of the heating element 102. The power source 103 may include a power supply circuit for transferring power received from an electrical outlet to the heating element 102. The power source 103 may be a power circuit configured to charge the one or more batteries. The power circuit may include an alternating current to direct current (ADC) converter.

The electrical connector 121 may connect the power source 103 to the electrical outlet. In some examples, the electrical connector 121 includes a conductive strip or tab (contact connection) along the track 12. In other example, the electrical connector 121 may be on the opposite side of the portable steam generator 21, but the track 12 aligns the electrical connector 121 to the conductive strip or tab. When the portable steam generator 21 is mounted on the track, the electrical connector 121 is electrically connected to the conductive strip or tab.

A retractable water outlet 122 may be configured to connect to a water supply line (e.g., utility water, well water) in the installation position. The retractable water outlet 122 may include a ball valve that receives a connector from the bathroom device. The retractable water outlet 122 may include a rotatable stem that is rotated in response to movement of the portable steam generator 21 along the track 12. Sliding the portable steam generator 21 along the track causes the retractable outlet 122 to extend into the water supply connector.

The power source 103 may also provide electrical power to the controller 100, the display 111, or other microelectronics. The controller 100 may be configured to control the operation of the portable steam generator 21. The controller 100 may also be connected to the display 111 for providing operational data to the user and input device 112 to receive commands from the user.

The controller 100 may select a mode of operation for the portable steam generator 21. Example modes of operation may include a sleep mode, a steam mode, a charging mode, a filling mode, or other modes. During the sleep mode, the steam generator (e.g., heating element 102) is turned off. During the steam mode, the steam generator (e.g., heating element 102) is turned on. The controller 100 may generate and send a switch command that connects the power source 103 to the heating element 102.

During the filling mode, which may overlap the sleep mode or the steam mode, the water supply is connected to the tank 101. The controller 100 may open a valve to connect the water supply to the tank 101.

During the charging mode, which may overlap the sleep mode, the steam mode, or the filling mode, the battery is connected to power to charge. The controller 100 may generate and send a charging command that connects power to the battery.

The controller 100 may be configured to detect the installation position and select a steam mode in response to the installation position. The portable steam generator 21 may include an electrical contact, a magnetic contact, or a mechanical contact that indicates which of the possible installation positions that the portable steam generator 21 is in. In this way, the controller 100 may determine whether the portable steam generator 21 is connected to a shower, a cabinet, or a bathtub. The controller 100 may select the charging mode and/or fill mode when the portable steam generator 21 is connected to the lavatory 15. When the portable steam generator 21 is removed and installed at the bathtub 16, the controller 100 may select the steam mode.

Various steam modes may be possible. Different temperatures may correspond to different steam modes. Different flow rates or volumes of steam may correspond to different steam modes. Default settings may determine these parameters. Alternatively, these parameters may be selected by the user.

A scent cartridge or module 113 may release a scent that is combined with the steam. The scent may be taken up using a wick in the tank 101. The wick may be retractable by a solenoid, which may be controlled by the controller 100 to turn the scent on or off or vary the degree of the scent. The scent module 113 may be removable.

An oil cartridge or module 114 may release oil that is combined with the steam. The oil may be taken up using a wick in the tank 101. The wick may be retractable by a solenoid, which may be controlled by the controller 100 to turn the oil on or off or vary the amount of oil added to the steam. The scent module 113 may be removable.

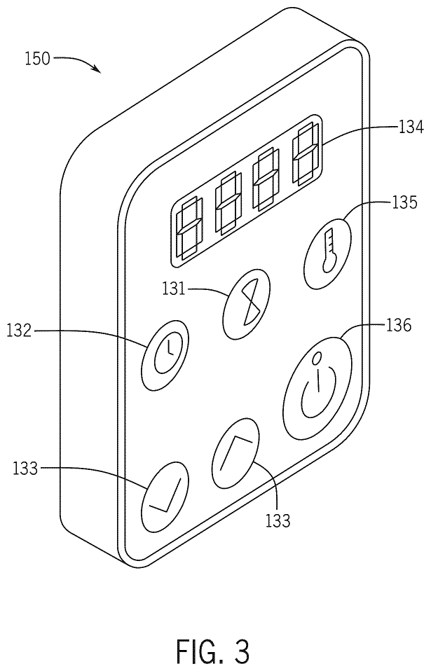

FIG. 3 illustrates an example user interface 150 for the portable steam generator 21. The user interface 150 may combine the display 111 and input device 112 of FIGS. 1 and 2. The user interface 150 may include a timer button 131, a schedule button 132, a selector 133 (e.g., up and down selectors as illustrated), a screen 134, a temperature button 135, and a power button 136. Additional, different, or fewer components may be included.

The power button 136 may be depressed to turn on and off the user interface 150. The power button 136 may also turn on and off the portable steam generator 21. That is, the heating element 102 may be off until the power button 136 is depressed, or depressed and held, and the screen 134 switches on to indicate the portable steam generator 21 is active.

The user may depress the timer button 131 and then simultaneously or sequentially the selector 133 to set a value for the timer. The timer may be set to an operation time for the portable steam generator 21 or the heating element 102 to run. Predefined timer settings (e.g., number of minutes or seconds) may be used.

The user may depress the schedule button 132 and then simultaneously or sequentially the selector 133 to set a value for the schedule. For example, the schedule may set operation to a time of day or day of the week. The timer may also set a charging schedule for the battery or water fill schedule for the tank 101. The schedule button 132 may also set the clock.

The user may depress the temperature button 135 and then simultaneously or sequentially the selector 133 to set a value for the temperature. The temperature value intervals may be predefined.

The screen 134 may display one or more parameter indicators (e.g., temperature, schedule, or timer) and a numeric value for the setting of the corresponding parameter.

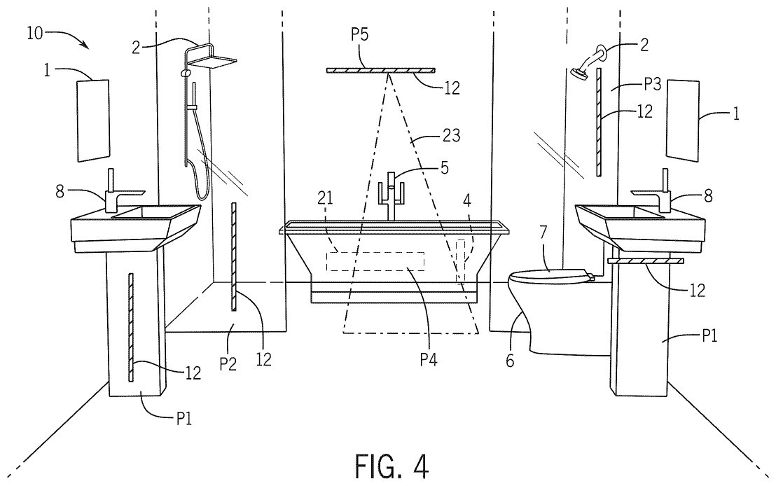

FIG. 4 illustrates example mounting locations for the portable steam generator 21 in a bathroom setting 10 that includes multiple appliances. The setting 10 includes mirror 1, shower 2, a bathtub sensory device 4, a toilet 6, a toilet seat 7, and a sink faucet 8. Additional, different, or fewer components may be included.

The portable steam generator 21 may be removably mounted on any of the tracks 12. Example positions for the portable steam generator 21 (the track 12 and rail 22) may be horizontal, vertical or at angle. Position P1 may be a pedestal of a sink. Position P2 may be a glass side wall of a shower. Position P3 may be a rear back wall of a shower (e.g., below showerhead 2). Position P4 may be in a bathtub. Position P5 may be near the ceiling. In one example, when the portable steam generator 21 is mounted at the position P5, the steam is released in a cloud or shape 23 over the bathtub.

The position P3 may also correspond to the installation panel for the portable steam generator in an integrated shower panel as described herein, which includes a single plumbing inlet that provides water distributed throughout the panel to multiple water outlets.

The controller 100 may activate different modes dependent on the mounting location of the portable steam generator 21 where the track 12 of the bathroom device mounts with the rail 22 of the portable steam generator 21. For example, certain positions such as P1, may have available charging power for the charging mode as well as water for the filing mode. In other positions, P2, P3, and P4, water may be available for the filing mode. In other examples such as P5, only the steam mode is available.

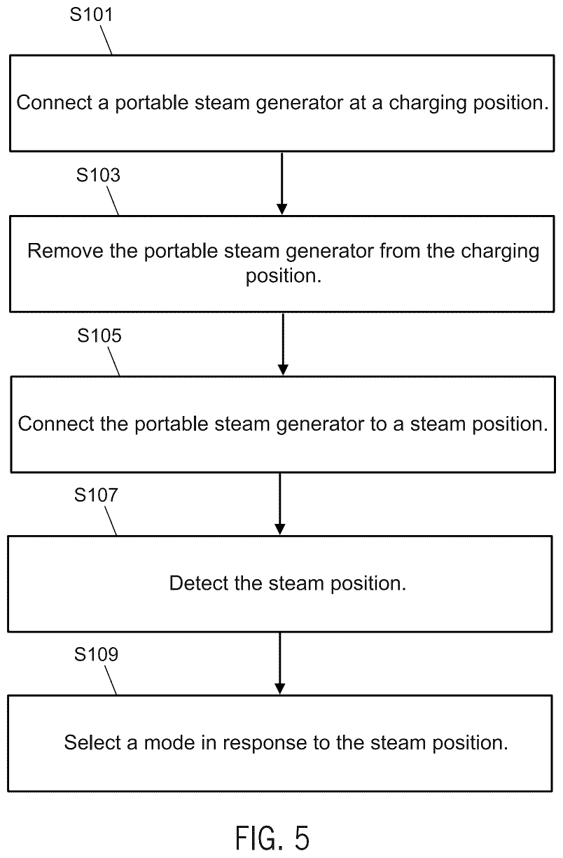

FIG. 5 illustrates a flow chart for the operation of the portable steam generator 21. Additional, different, or fewer acts may be included.

At act S101, the user connects the portable steam generator 21 to a first track associated with a charging position. The first track may be in a dry location such as a cabinet or lavatory where a power source is available. The charging position may be in electrical connection with a charger that is connected to a wall outlet or hard wired to a house or building. The charging position may have a first orientation such that the portable steam generator 21 faces away from the user. For example, in the charging position, the portable steam generator 21 may be oriented vertically in the cabinet. In another example, the portable steam generator 21 may be mounted with respect to a cover that blocks the user interface 150.

At act S103, the user removes the portable steam generator 21 from the first track. The portable steam generator 21 may be removed by sliding the portable steam generator 21 with respect to the first track (in a direction opposite to S101). The portable steam generator 21 may be decoupled using a fastener.

At act S105, the user connects the portable steam generator to a second track associated with a steam position. The second track may be integrated with or coupled to a bathroom device such as a bathtub or shower. The portable steam generator 21 may be slide along the second track to physically mount with one or more rails.

At act S107, the controller 100 detects the steam position. For example, the second track may include or be adjacent to one or more communication devices that allows the controller 100 to detect that the portable steam generator 21 has been mounted to the second track. In one example, the communication device includes an electrical connection such that an electrical connection is made between the second track (or corresponding mounting position) and the controller 100. In another example, the communication device includes a magnet in a predetermined pattern such that the controller 100 can unilaterally detect the position (and presence) of the second track. Other wireless communication such as Bluetooth, radio frequency identification (RFiD), near field communication (NFC) or others may be used.

At act S109, the controller 100 selects a mode in response to the steam position. In one example, the controller 100 may receive a recommendation from a wellness hub, as described in other embodiments and select the mode for the portable steam generator 21 in response to the recommendation.

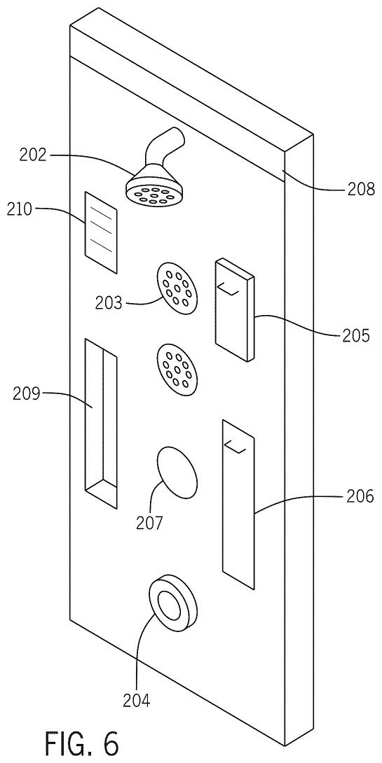

FIG. 6 illustrates an example integrated shower panel 200. The integrated shower panel 200 includes a housing 201, a showerhead 202, one or more body sprays 203, a steam port 204, a towel sanitizer 205, a towel warmer 206, a scent outlet 207, a chroma therapy device 208, and a sundry storage 209. Additional, different or fewer components may be included.

The integrated shower panel 200 includes multiple device integrated into a single installation and water source. The plumbing inlet to the integrated shower panel 200, which may be a flexible tube or other pipe that connects to a rough in or a shower arm pipe. Within the integrated shower panel 200 are one or more plumbing fixtures and/or valves to provided water to multiple devices. Thus, at least one water outlet is connected to the plumbing inlet, and the at least one water outlet may include the showerhead 202, one or more body sprays 203, and the steam port 204.

One example outlet is a steam port 204 may be connected to a steam generator such as the portable steam generator 21. The steam generator may include at least a water tank and a heating element. The heating element provides heat to the water in the water tank to generate steam. Other example outlets include the outlet of showerhead 202 and the outlet one or more body sprays 203. The sanitizing unit (e.g., towel sanitizer 205) may also outlet water.

A pipe network within the housing 201 may supply water from the plumbing inlet to the various outlets of the integrated shower panel 200. The pipe network may include multiple valves for directing water from the plumbing inlet to the at least one water outlet 202, the at least one steam outlet 204, and the at least one sanitizing outlet 205.

The controller 100 is configured to operate the valves so that different devices may be operated at different times. The controller 100 may apply a predetermined sequence to the devices to promote a reduced shower time and/or reduced water consumption. The predetermined sequence may be selectable according to the available devices. Water credits may be applied so that the total time available on the various devices varies according to water consumption. A 10 minute steam may be equivalent to a five minute shower.

The towel sanitizer 205 may be connected to a sanitizing unit including an additive generator that outputs a sanitizing fluid. The sanitizing unit may also include a water tank and be connected to the plumbing inlet for a source of water. In addition to the towel sanitizer 205, the sanitizing fluid may be added to the steam. The towel sanitizer 205 may include a sanitizing chamber with a hook or another type of towel holder for supporting one or more towels. The sanitizing fluid may be released into the sanitizing chamber and absorbed by the towel.

The sanitizing unit may include an ozone generator. The controller 100 may send commands to turn the ozone generator on and off. The controller 100 may send commands for a level of ozone the ozone generator or a metering device connected to the ozone generator. Ozone, or trioxide or O₃, is an inorganic molecule and reactive gas. Ozonated water that is output from the sanitizing fluid is a disinfectant that may be used to sanitize the towel as well as other objects or surfaces in the shower. Ozone may be formed by the sanitizing unit using a variety of techniques, including corona discharge, ultraviolet light, cold plasma, and other techniques. Any of these devices may be operated by the controller 100. For example, a corona charger may be configured to accumulate electric charge from a power source and apply the electric charge to air from an air source. In corona discharge, a corona discharge tube or an ozone plate is used. For example, a high voltage may be applied to an electrode in discharge tube or on the ozone plate. A corona discharge is an electrical discharge caused by the ionization of air surrounding the conductor carrying the high voltage. The air around the conductor undergoes an electrical breakdown to become conductive (e.g., temporarily) so that charge can leak off of the conductor and into the air. A corona occurs at locations where the strength of the electric field (potential gradient) around a conductor exceeds the dielectric strength of the air.

In addition or in the alternative, the sanitizing unit may include an electrolyzed water generator. Electrolyzed water may be referred to as electrolyzed oxidizing water, electro-activated water or electro-chemically activated water solution. Electrolyzed water may be generated by the electrolysis of water (e.g., ordinary water or tap water) with dissolved sodium chloride therein. The electrolysis may produce hypochlorous acid and sodium hydroxide. The electrolysis may include apply a direct current (DC) power source connected to multiple electrodes plates constructed from electroconductive material such as metal. An electrolyzed water reactor may perform electrolysis within the sanitizing unit via a cathode and anode.

The controller 100 may be configured to turn on and off an electric current to the cathode and/or the anode. The controller 100 may provide a charge or bias to the cathode to generate the electric current between the cathode and the anode. The controller 100 may operate a valve to add the neutralizing agent to the reactor from a neutralizing agent compartment.

The controller 100 may send commands to the sanitizing unit to control sanitizing in the towel sanitizer 205 or the steam outlet 204. For example, the commands may initiate the generation of the additive. The commands may be triggered by a time schedule (e.g., once every predetermined time period or at certain times of day). The commands may be triggered by flow in the water supply. The controller 100 may send a command to the water treatment device to generate the additive in response to a user input. For example, the controller 100 may operate the sanitizing unit for a predetermined time after the user input is triggered.

In some embodiments, the user input may be a sensor (e.g., a proximity sensor) and the rinse cycle may be automatically initiated (e.g., by a controller) based on sensor data received from the sensor.

The towel warmer 206 may include a heating element and a container for towels. The towel warmer 206 may include a hook or other support for the towel in proximity to the heating element. The scent outlet 207 may include a cartridge to emit scents from the integrated shower panel 200. The chroma therapy device 208 may include one or more lights under control of the controller 100. The sundry storage 209 may be an additional shelf or chamber in the integrated shower panel 200 for the user to place objects.

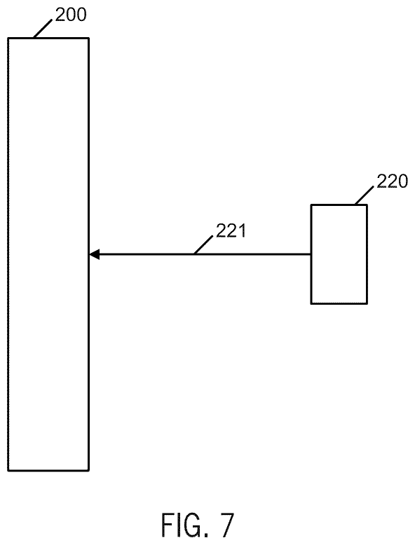

FIG. 7 illustrates an example recirculation system for the integrated shower panel 200. The recirculation system includes a drain 220 and a return pipe 221 coupled to the integrated shower panel 200. Some of the water that is dispensed through the outlets of the integrated shower panel 200 is collected and returned to the integrated shower panel 200. The returned water may be used for specific uses. For example, the recirculated water may only be provided to the showerhead 202 or heated by the steam generator for the steam outlet 204.

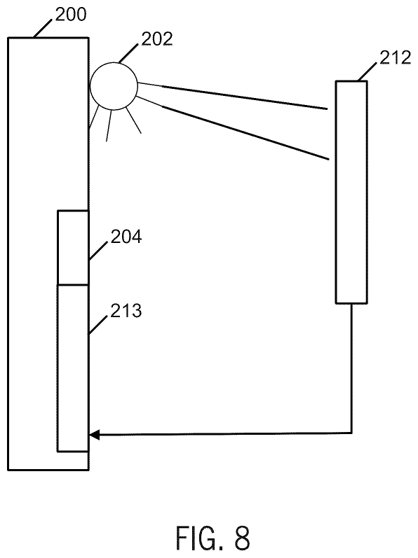

FIG. 8 illustrates another example recirculation system for the integrated shower panel 200. The recirculation system includes a catch tray 212 and a recirculation tank 213. Additional, different, or fewer components may be included.

The catch tray 212 may be positioned in a variety of positions to collect water from the at least one water outlet. For example, the catch tray 212 may be near the floor of the shower. As shown by FIG. 8, the catch tray 212 is positioned to collect water from showerhead 202 at a position that may have substantially avoided other objects. In other words, water that passes the user of the shower without contact is collected by the catch tray 212 and water that falls to floor is collected by a drain that is separate from the recirculation system. The catch tray 212 may provide the water to a recirculation water tank 213. In some examples, the water supply for the steam generator and steam outlet 204 is provided by the water tank 213.

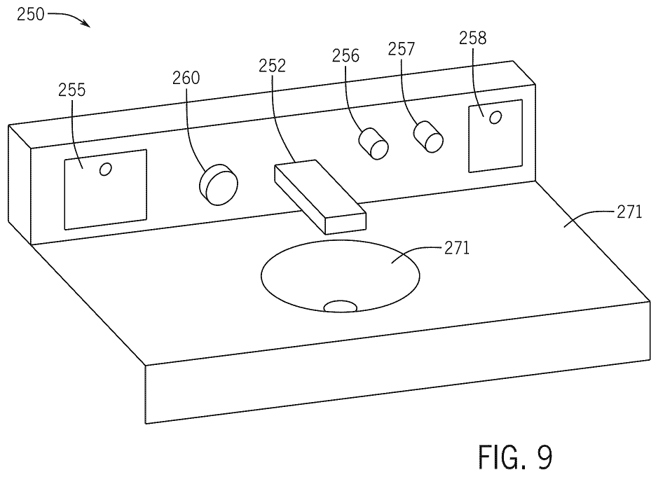

FIG. 9 illustrates an example integrated lavatory panel 250 as another example of a pre-plumbed integrated bathroom panel. The integrated lavatory panel 250 includes a plumbing inlet, a conversion outlet 252, a towel sanitizer 255, a first dispenser 256, a second dispenser 257, an accessory compartment 258, a control interface 260, a basin 271, and a countertop 272. Additional, different, or fewer components may be included.

One or more outlets may be associated with a sanitizer generator as described herein. For example, the towel sanitizer 255 may receive sanitizer, such as ozone or electrolyzed water, from the sanitizer generator. In addition, the accessory compartment 258 may sanitize another object through fluid connection with the sanitizer generator. Examples for the other object may include a toothbrush, hairbrush, comb, glasses, shaver, or other objects.

The integrated lavatory panel 250 includes a single plumbing inlet configured to provide water to the integrated lavatory panel 250 for the output of the towel sanitizer 255 and the conversion outlet 252. The conversion outlet 252 may be convertible to dispense water in a first configuration and steam in a second configuration. The conversion outlet 252 may have a switch that switches between the water supply and the steam supply. The switch may be mechanical. The conversion outlet 252 may include a lever that switches a valve within the integrated lavatory panel 250 to open/close a pipe to the water supply and/or open/close a pipe to the steam generator.

The switch may also include electronic switching. The control interface 260 may receive a selection for water or steam. A solenoid or other type of valve may be actuated in response to the selection to select either water supply or steam supply for the outlet 262. The controller 100 may operate the solenoid or valve in response to the selection from the control interface 260.

Alternatively, the controller 100 may operate the switch in response to sensor data. The sensor data may describe the temperature of the room. The sensor data may be responsive to gestures, voice commands, or other movements of the user.

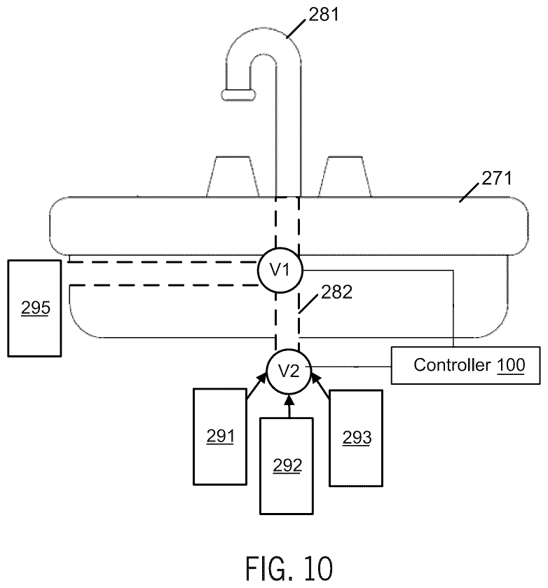

The first dispenser 256 and the second dispenser 257 may be operated by manual buttons (e.g., pressure pump depressed by the user) or an electronic pump operated by the controller 100. Examples substances for the first dispenser and/or the second dispenser 257 may include soap, toothpaste, cream, gel, and lotion. The dispensers 256 and 257 may be integrated with the outlet 252, as shown by FIG. 10, or spaced apart from the outlet 252, as shown by FIG. 9.

The integrated shower panel 200 or the integrated lavatory panel 250 may also communicate with the wellness hub described herein via a communication interface. The integrated shower panel 200 or the integrated lavatory panel 250 may receive a recommendation indicative of the at least one water outlet, at least one steam outlet, and at least one sanitizing outlet and illuminate a guide light (e.g., projected light or LED) in response to the recommendation.

FIG. 10 illustrates an example dispensing system for a lavatory. A single faucet 281 may be connected to a water supply as well as multiple other containers including substances that may be dispensed through the faucet 281. The faucet 281 is a dispenser configured to dispense a variety of substances and one or more valves operate as a dispenser switch configured to switch the dispenser among the substances. Example substances include soap, toothpaste, cream, gel, and lotion.

One of the example containers 295 may be coupled or otherwise integrated with a steam generator, an ozone generator, or an electrolyzed water generator as described herein. A valve or switch V1 may switch the outlet of the faucet between the container 295, the water supply, and an auxiliary path 282.

The auxiliary path 282 may be connected to one or more auxiliary containers 291, 292, and 293 via a valve or switch V2. Example substances for the auxiliary containers may include soap, sanitizing fluid, or other cleansers. The controller 100 may actuate valves V1 and V2 to control the output of the faucet 281.

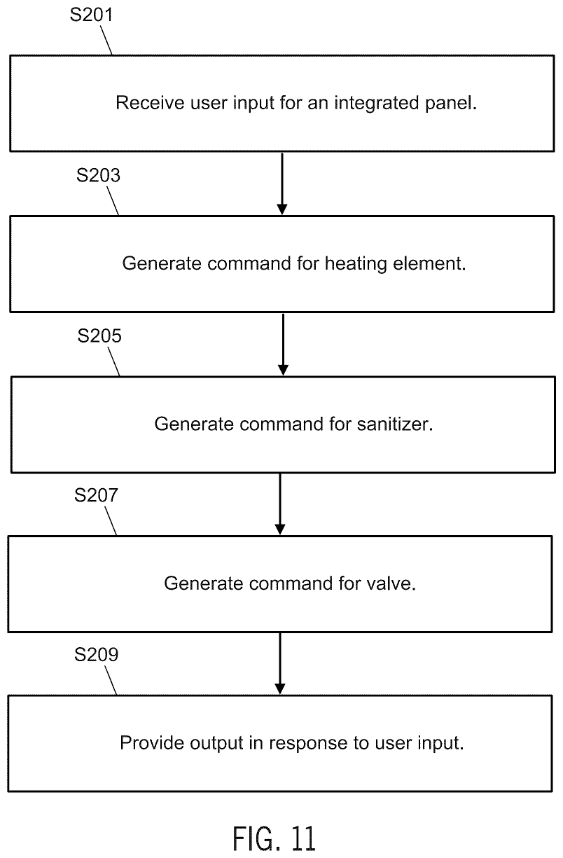

FIG. 11 illustrates a flow chart for the integrated lavatory panel. Additional, different, or fewer acts may be included.

At act S201, the controller 100 receives a user input. The user input may select an output sequence for at least one outlet of the integrated panel. The output sequence may include an order for water and steam to be output from the faucet 281. The output sequence may include an order for a first type of water and a second type of water to be output from the faucet 281.

At act S203, the controller 100 generates a first command for an electrical element (e.g., heating element) in response to the output sequence. The heating element may generate steam according to the output sequence. The heating element may generate hot water according to the output sequence.

At act S205, the controller 100 generates a second command for an additive generator (e.g., sanitizer) in response to the output sequence. The second command may cause release of the additive. The second command may energize an electrical element to generate the additive. The electrical element may include an ozone generator or an electrolyzed water generator.

At act S207, the controller 100 generates at least a third command for a valve associated with the at least one outlet. The valve controls the output of the faucet 281 to release the sanitizer. The valve may control the faucet 281 to release the water and sanitizer at difference times according to the output sequence.

At act S209, the integrated panel provides output through the faucet 281 or in other examples, multiple outlets in response to the user input according to the output sequence.

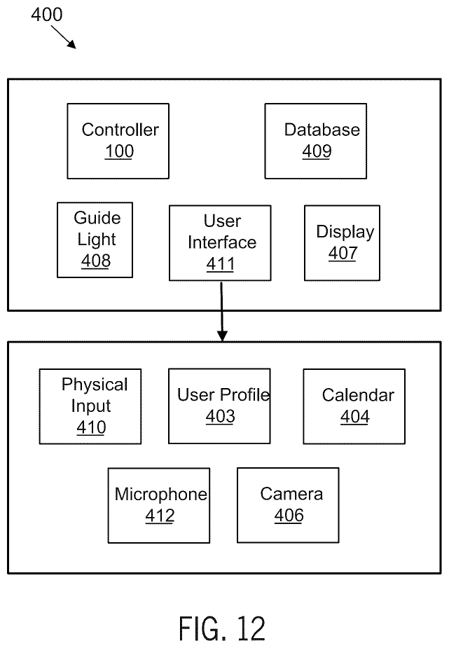

FIG. 12 illustrates an example recommendation system 400, which may be referred to as a wellness hub, including a controller 100, a user interface 411, a display 407, a guide light 408, and a database 409.

The recommendation system 400 may communicate with one or more sensors or other devices for obtaining wellness inputs from/for a user. Examples include physical input 410, a user profile 403, a calendar 404, a microphone 412, and a camera 406. Additional, different or fewer components may be included.

The recommendation system 400 or wellness hub may be incorporated into a variety of devices. For example, the integrated shower panel 200 may include the recommendation system 400.

The recommendation system 400 may be built in to a mirror. For example, mirror 1 may include camera 406, the microphone 412, and other sensors for collecting user wellness data based on appearance and sound of the user. The mirror 1 may include physical inputs 410 for wellness data. The mirror 1 may include the controller 100, or send the wellness data to a server, for analyzing wellness based on the wellness inputs. The mirror 1 may determine via the controller or receive from the server recommendations for experiences or products that can may improve the user's health and feeling.

The recommendation system 400 or wellness hub may be incorporated into a standalone device as the wellness hub. The wellness hub may be configured to receive voice commands from the user and provide audio or displayed recommendations in response to analysis of inputs. The analysis may occur locally (e.g., at controller 100) or remotely (e.g., at a server) in communication with the wellness hub through the internet or another network. In some examples, the wellness hub is implemented on a smartphone or tablet.

The user interface 411 may include a touchpad, keyboard, or other input configured to receive one or more wellness inputs from the user. That is, the user may answer questions or otherwise rate the current well being or health of the user. Other wellness inputs may be determined from the camera 406,

The controller 100 is configured to perform an analysis of the one or more wellness inputs and select a bathroom device in response to the analysis. The controller 100 identifies a user feeling comprising a stressed feeling, a sick feeling, or an anxious feeling from the analysis.

The camera 406 may collect image data for the user. The controller 100 may perform an image analysis on the image data to identify a health or wellness characteristic of the user.

The physical input 410 may collect image data for the user. The physical input 410 may include a thermometer or other measurement device. The controller 100 may compare the data from the physical input 410 to a predetermined threshold to determine a health or wellness characteristic of the user.

The calendar data 404 may include habits or other information related to the schedule of the user. The calendar data 404 may be entered by the user on another device. The calendar data 404 may be inferred from the detected behavior of the user (e.g., wake times, sleep routines, bathing routines, use of bathroom devices). The calendar data 404 may be downloaded from a server or other external device. The controller 100 may analyze the calendar data 404 to estimate a health or wellness characteristic of the user.

The user profile data 403 may include medical histories or family information for the user. The calendar data 403 may be entered by the user. The calendar data 404 may be downloaded from a server or other external device.

The microphone 412 may collect audio data associated with the user. The audio data may include voice data. The controller 100 may analysis the audio data to determine a health or wellness characteristic of the user.

The display 407 is configured to provide a recommendation including the selected bathroom device. Images or alphanumeric messages may instruct the user what bathroom device to use and what settings to apply to the selected bathroom device.

The database 409 may log the recommendations and activities of the user. Each activated device may be recorded along with a time stamp and/or date stamp. The compliance of the user (e.g., following the recommendation of the recommendation system 400) may be logged.

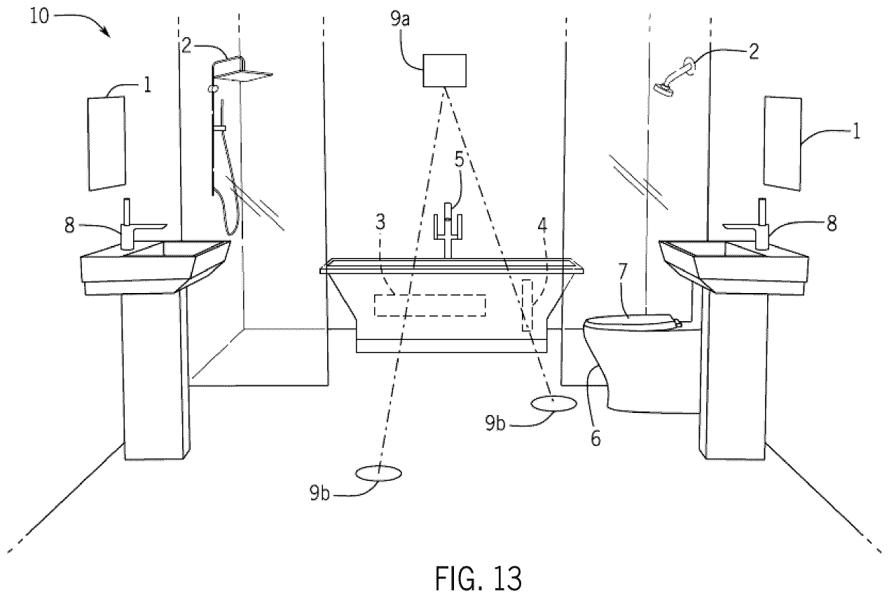

FIG. 13 illustrates an example light guide projector 9 for the recommendation system 400 in a bathroom setting 10 that includes multiple appliances. The setting 10 includes mirror 1, shower 2, a bathtub sensory device 4, a toilet 6, a toilet seat 7, a sink faucet 8, and light source 9 configured to project light guides 19. The light guides 19 may be projected onto any of the appliances. The light source 9 may include one or more motors or other actuators in one, two, or three axes. The controller 100 is configured to control the actuators to point the light guides 19 anywhere in the bathroom setting 10.

As illustrated, the light guide source 9 may be mounted on the ceiling. In location for the light guide source 9 is possible. The light guide source may be supported by the integrated shower panel 200 or lavatory 250 including a single plumbing inlet, as described in other embodiments herein.

The light guide 19 and recommendation system 400 may provide instructions for a daily routine through a choreographed, custom health circuit experience. The light guides 19 instruct the user where to go next with lighting, time sequence for each segment (hot/cold shower, dual-chamber hot/cold plunge tub, steam space and/or sauna space) of the recommendation sequence.

The light guide 19 may instruct the user to make specific selections on a bathroom device. The light guide 19 may first instruct the user to turn on the shower by projection overlaid on a shower lever. The light guide 19 may next instruct the user to turn on a steam outlet by projection overlaid on a steam button.

For a lavatory, the light guide 19 may first instruct the user to turn on the water by projection overlaid on a water valve. The light guide 19 may next instruct the user to dispense a cleansing solution by projection on a dispenser.

For a bath, the light guide 19 may first instruct the user to turn on the water by project overlaid on a water valve. The light guide 19 may next instruct the user to dispense scent or oils by projection on a scent module.

The light guide 19 may specify certain actions with an animation in the light. The animation may be a video sequence. The light guide 19 may specify certain actions by color. A first color may indicate turning on a device and a second color may indicate turning off a device. Likewise, a first color may indicate increasing a temperature setting and a second color may indicate decreasing a temperature setting.

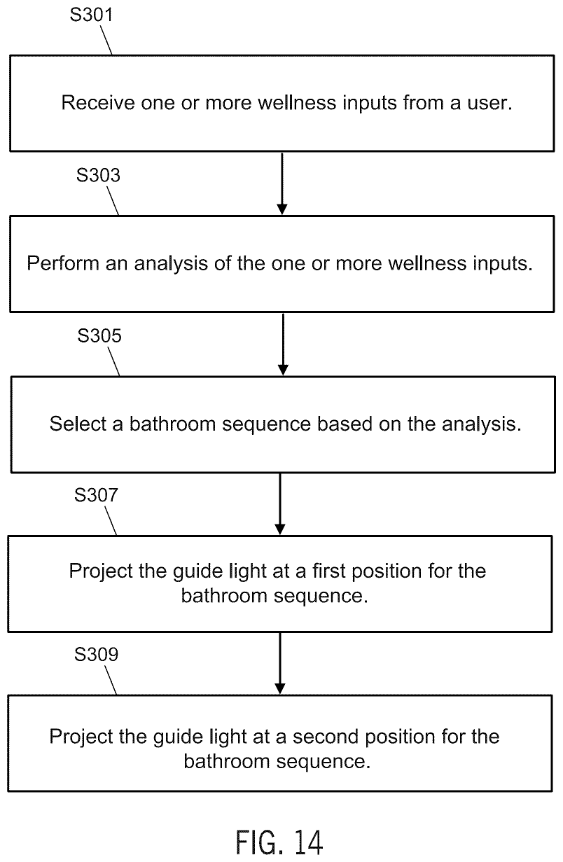

FIG. 14 illustrates a flow chart for the recommendation system. Additional, different, or fewer components may be included.

At act S301, the controller 100 receives one or more wellness inputs from a user. Wellness inputs may include image data such as collected by camera 406 including the appearance of the user. The wellness inputs may include audio data as collected by microphone 412. Wellness inputs may include sensor data such as collected by a temperature sensor or other sensor.

At act S303, the controller 100 performs an analysis of the one or more wellness inputs. The controller 100 may compare the wellness input values to one or more predetermined values or ranges of values. The controller 100 may also determine a number of wellness inputs that exceed the predetermined values or ranges. The controller 100 may also compare the set of wellness values to a particular pattern or matrix (e.g., comparing multiple thresholds to the set of wellness values) in order to determine whether the wellness inputs indicates a particular state for the user.

At act S305, the controller 100 selects a bathroom sequence in response to the analysis. That is, the controller 100 may look up a bathroom sequence based on the state of the user determined in S303.

At act S307, the controller 100 projects a guide light to a first location corresponding to the bathroom sequence. At act S309, the controller 100 projects a guide light to a second location corresponding to the bathroom sequence.

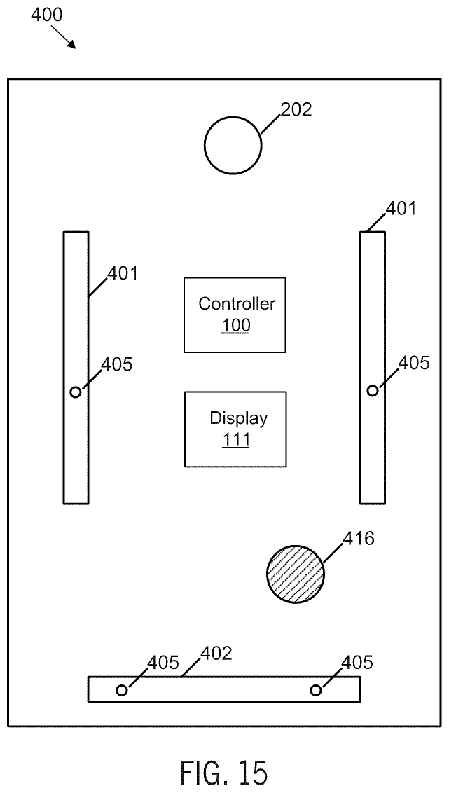

FIG. 15 illustrates an example shower exercise system 400. The shower exercise system 400 may be configured for yoga routines in the shower. In some examples, a single assembly or panel includes a showerhead 202, at least one grab bar 401, and a shower mat 402 below the at least one grab bar 401. The shower mat 402 may be positioned for the user to stand on the shower mat 402 at a foot position while gripping the grab bar 401. In other examples, the shower mat 402 may be positioned in front of the user's feet. Additional, different, or fewer components may be included.

The panel or assembly for the exercise system 400 may also include a controller 100 and a display 111, which may be integrated with a user input. The user may enter or select a yoga sequence. The yoga sequence may include multiple positions for the user in time (e.g., a first position followed by a second position). In addition, the controller 100 may include a communication interface configured to communicate with a wellness hub to receive a recommendation indicative of the yoga sequence.

The controller 100 may send commands to a plurality of light indicators 405 corresponding to the yoga sequence. The light indicators 405 may be mounted on the at least one grab bar 401 and the shower mat 402. Each light indicator 405 may include indicia or different colors that correspond to different appendages (e.g., left hand, right hand, left foot, right food). Thus, the controller 100 through the light indicators 405 instruct the user to place hands and feet in certain positions with respect to the at least one grab bar 401 and the shower mat 402.

The display 111 may also display at a status of the yoga sequence. The status may include a numerical value for the step of the yoga sequence. The display 111 may also instruct the user to place hands and feet in certain positions with respect to the at least one grab bar 401 and the shower mat 402. The controller 100 may include a timer that counts time for the yoga sequence. The display 111 may display the countdown of the timer. A speaker also may be included in the panel of the exercise system 400. The controller 100 is configured to send audio signals to the speaker corresponding to the yoga sequence.

A sensor may detect the user's position or the user's movement with respect to the exercise system 400. The sensor may be a proximity sensor. A sensor may be present on each of the grab bars 401 and each foot position of the shower mat 402. Each of the stages of the yoga sequence may be associated with one or more positions. The controller 100 is configured to determine whether the sensors of the positions of a first stage in the sequence have triggered from the user's position. In response, the controller 100 may start the timer and when a predetermined time for the first stage has been met, the controller 100 proceeds to a second stage.

The panel or assembly of the exercise system may also include a steam outlet 416. The controller 100 may open or close a valve for the steam outlet 416 or a heating element (steam generator) for the steam outlet 416 in response to a particular stage of the yoga sequence. The panel or assembly of the exercise system may also be integrated with the shower panel 200 or lavatory panel 250 described herein including a single plumbing inlet for multiple water outlets.

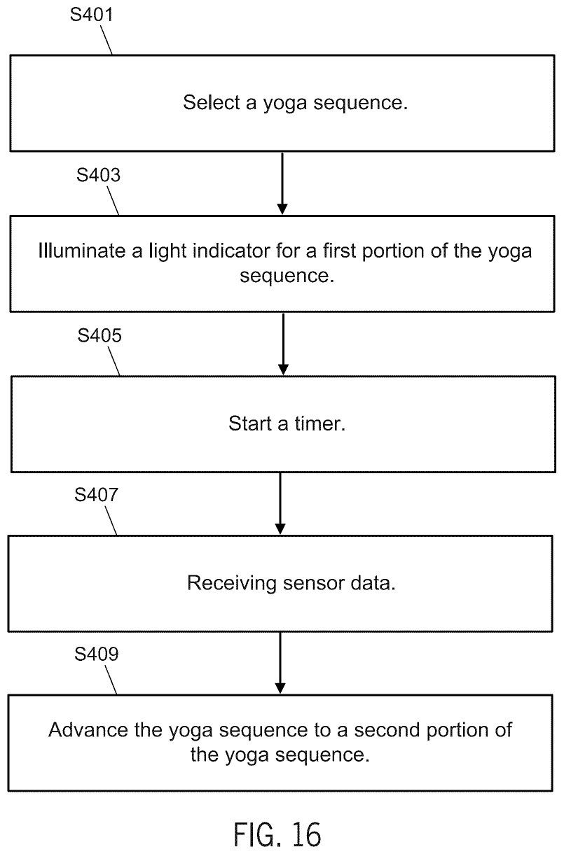

FIG. 16 illustrates an example installation sequence for the shower exercise system. Additional, different, or fewer components may be included.

At act S401, the controller 100 selects a yoga sequence. At act S403, the controller 100 sends commands to illuminate a light indicator at a shower grab bar or a shower mat for a first portion of the yoga sequence. At act S405, the controller 100 starts a timer. At act S407, the controller 100 receives data from a sensor. At act S409 the controller 100 advances the yoga sequence to a second portion in response to the timer reaching a predetermined time or the data from the sensor indicating the first portion of the yoga sequence is finished.

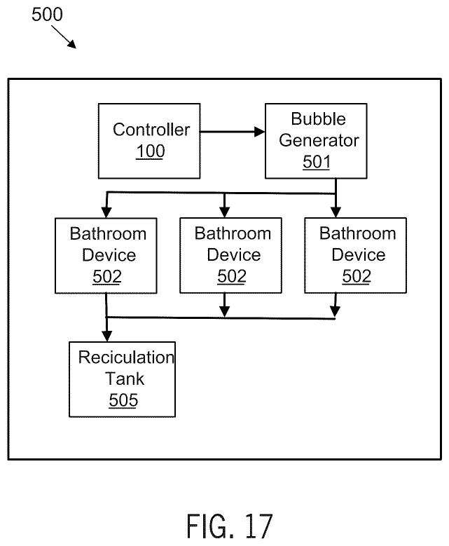

FIG. 17 illustrates an example a bubble generation system 500 including a bubble generator 501 connected to multiple bathroom devices 502. In some examples, the bathroom devices 502 may also be connected to a recirculation tank 505. The bubbles from the bubble generator 501 act as whole home filtration. Every touchpoint with water delivery in the home (shower, kitchen, faucet, bathroom, bathtub) is facilitated with the pure, clean, high-quality water. Additional, different, or fewer components may be included.

The bubble generation system 500 may be connected to a water source. The bubble generator 501 may generate microbubbles having a diameter of less than 100 micrometers. Alternatively, the bubble generator 501 may generate nanobubbles having a diameter of less than 200 nanometers. The bubble generator 501 may provide a combination of microbubbles and nanobubbles that filters or otherwise purifies the water.

The bubble generator 501 provides the microbubbles and/or nanobubbles to the flow of water and into a pipe network configured to deliver the water with the microbubbles to plumbing fixtures. The bubble generator 501 may inject the bubbles into the water flow using a venturi. Some of the plumbing fixtures may be associated with bathroom devices such as lavatories, showers, bathtubs, steam outlets, or toilets. Some of the plumbing fixtures may be associated with kitchen devices such as faucets or dishwashers. Other devices such as washing machines, water heaters, water softeners, or others may be included. The bubble generation system 500 may be combined with the integrated shower panel 200 or integrated lavatory panel 250 including a single plumbing inlet for multiple water outlets.

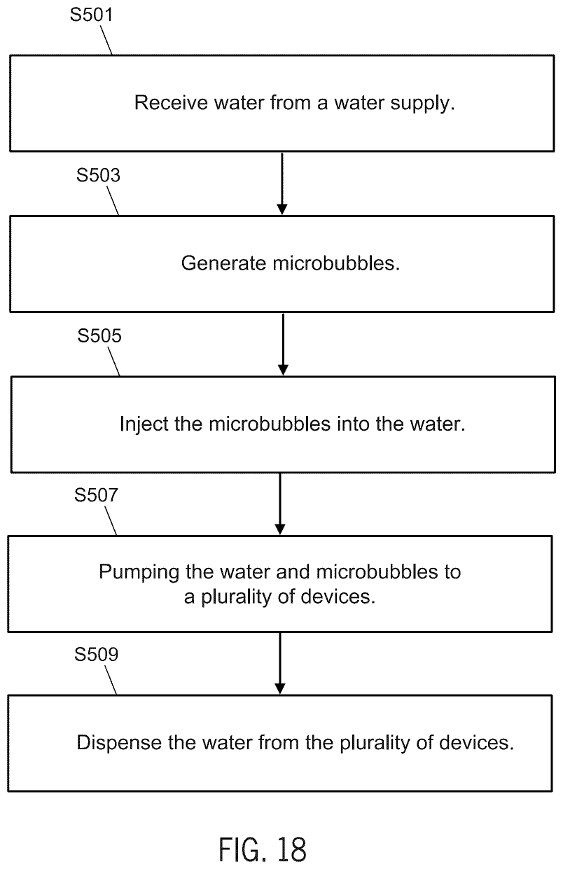

FIG. 18 illustrates an example flow chart for the bubble generation system. Additional, different or fewer acts may be included.

At act S501, the bubble generation system 500 receives water from a water supply. At act S503, the bubble generation system 500 generates the bubbles. The bubble generation may be in response to a recommendation from a wellness hub as described herein. The water and microbubbles are dispensed at the bathroom device in response to the recommendation. At act S505, the bubble generation system 500 injects the microbubbles into the water. At act S507, the bubble generation system 500 pumps the water and the microbubbles to a plurality of plumbing fixtures. At act S509, the water and microbubbles are dispensed at one or more bathroom devices connected to the plumbing fixtures.

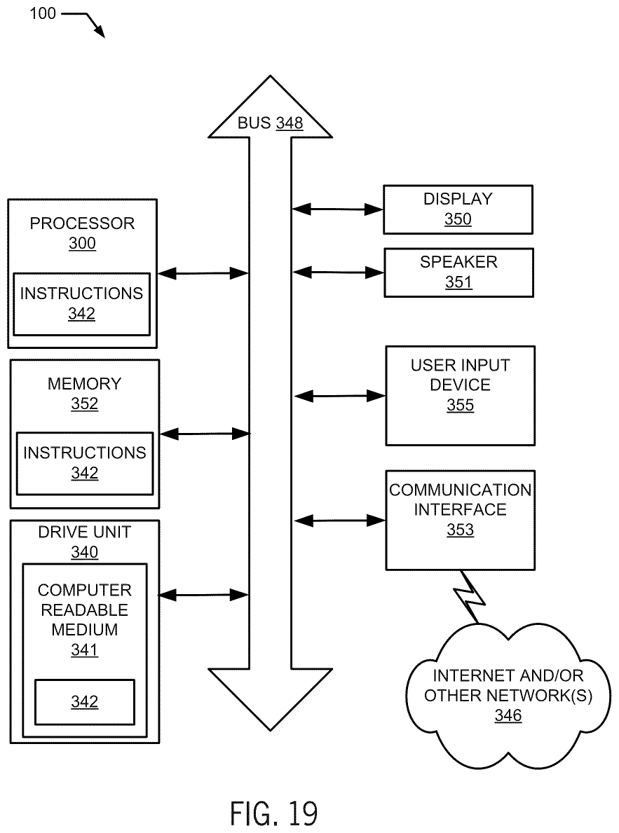

FIG. 19 illustrates an example control system or controller 100 for any of the embodiments described herein. The controller 100 may include a processor 300, a memory 352, and a communication interface 353 for interfacing with devices or to the internet and/or other networks 346. In addition to the communication interface 353, a sensor interface may be configured to receive data from the sensors described herein or data from any source. The controller 100 may include an integrated display 350 (projector), speaker 351, or other output devices. The components of the control system may communicate using bus 348. The control system may be connected to a workstation or another external device (e.g., control panel) and/or a database for receiving user inputs, system characteristics, and any of the values described herein.

Optionally, the control system may include an input device 355 and/or a sensing circuit 356 in communication with any of the sensors. The sensing circuit receives sensor measurements from sensors as described above. The input device may include any of the user inputs such as buttons, touchscreen, a keyboard, a microphone for voice inputs, a camera for gesture inputs, and/or another mechanism.

Optionally, the control system may include a drive unit 340 for receiving and reading non-transitory computer media 341 having instructions 342. Additional, different, or fewer components may be included. The processor 300 is configured to perform instructions 342 stored in memory 352 for executing the algorithms described herein. A display 350 may be an indicator or other screen output device. The display 350 may be combined with the user input device 355.

Processor 300 may be a general purpose or specific purpose processor, an application specific integrated circuit (ASIC), one or more programmable logic controllers (PLCs), one or more field programmable gate arrays (FPGAs), a group of processing components, or other suitable processing components. Processor 300 is configured to execute computer code or instructions stored in memory 352 or received from other computer readable media (e.g., embedded flash memory, local hard disk storage, local ROM, network storage, a remote server, etc.). The processor 300 may be a single device or combinations of devices, such as associated with a network, distributed processing, or cloud computing.

Memory 352 may include one or more devices (e.g., memory units, memory devices, storage devices, etc.) for storing data and/or computer code for completing and/or facilitating the various processes described in the present disclosure. Memory 352 may include random access memory (RAM), read-only memory (ROM), hard drive storage, temporary storage, non-volatile memory, flash memory, optical memory, or any other suitable memory for storing software objects and/or computer instructions. Memory 352 may include database components, object code components, script components, or any other type of information structure for supporting the various activities and information structures described in the present disclosure. Memory 352 may be communicably connected to processor 300 via a processing circuit and may include computer code for executing (e.g., by processor 300) one or more processes described herein. For example, the memory 352 may include graphics, web pages, HTML files, XML files, script code, shower configuration files, or other resources for use in generating graphical user interfaces for display and/or for use in interpreting user interface inputs to make command, control, or communication decisions.

In addition to ingress ports and egress ports, the communication interface 353 may include any operable connection. An operable connection may be one in which signals, physical communications, and/or logical communications may be sent and/or received. An operable connection may include a physical interface, an electrical interface, and/or a data interface. The communication interface 353 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

While the computer-readable medium (e.g., memory 352) is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A portable steam generator comprising:
a power source in a housing;
a water tank in the housing;
a heating element in the housing and configured to heat water in the water tank to produce steam using power from the power source; and
a track on the housing configured to support the portable steam generator in an installation position and allow manual removal from the installation position.

2. The portable steam generator of claim 1, wherein the power source includes one or more batteries.

3. The portable steam generator of claim 1, wherein the power source includes a power supply circuit.

4. The portable steam generator of claim 1, wherein the portable steam generator is movable between a cabinet to a shower.

5. The portable steam generator of claim 1, wherein the track is configured to mate with a fixed track associated with a bathroom fixture.

6. The portable steam generator of claim 5, wherein the fixed track is coupled to a shower, a cabinet, or a bathtub.

7. The portable steam generator of claim 1, further comprising:
a scent module configured to release a scent with the steam.

8. The portable steam generator of claim 1, further comprising:
an oil module configured to release oil with the steam.

9. The portable steam generator of claim 1, further comprising:
a contact connection coupled to the power source when the portable steam generator is attached to a bathroom fixture.

10. The portable steam generator of claim 1, wherein the power source is a battery including a contact for a battery charger.

11. The portable steam generator of claim 1, further comprising:
a controller configured to generate a steam command for the portable steam generator.

12. The portable steam generator of claim 11, further comprising:
an input device configured to communicate with the controller.

13. The portable steam generator of claim 11, wherein the controller is configured to detect the installation position and select a steam mode in response to the installation position.

14. The portable steam generator of claim 11, wherein the controller is configured to detect a shower, a cabinet, or a bathtub and select a steam mode in response.

15. The portable steam generator of claim 11, wherein the installation position is supported by an integrated shower panel including a single plumbing inlet.

16. A shower assembly comprising:
a fixed track configured to mate with a portable steam generator at an installation position; and
a plumbing fixture configured to supply water to the portable steam generator at the installation position.

17. The shower assembly of claim 16, further comprising:
the portable steam generator comprising:
a power source in a housing;
a water tank in the housing;
a heating element in the housing and configured to heat water in the water tank to produce steam using power from the power source; and
a track on the housing configured to support the portable steam generator in the installation position with the fixed track and allow manual removal from the installation position.

18. A method for operation of a portable steam generator, the method comprising:
connecting the portable steam generator to a first track associated with a charging position;
removing the portable steam generator from the first track; and
connecting the portable steam generator to a second track associated with a steam position.

19. The method of claim 18, further comprising:
detecting the steam position in response to connection to the second track; and
selecting a mode in response to the steam position.

20. The method of claim 19, further comprising:
receiving a recommendation from a wellness hub; and
selecting the mode in response to the recommendation.

21-87. (canceled)
